(19) United States
(12) Patent Application Publication
(10) Pub. No.: US 2025/0017137 A1
(43) Pub. Date: Jan. 16, 2025

(54) RAKE ASSEMBLY

(71) Applicant: The Ames Companies, Inc., Camp Hill, PA (US)

(72) Inventors: Ryan Barclay BISHOP, Ocala, FL (US); Joshua O. MULLEN, Duncannon, PA (US); Benjamin STOUT, Camp Hill, PA (US)

(21) Appl. No.: 18/770,752

(22) Filed: Jul. 12, 2024

Related U.S. Application Data
(63) Continuation-in-part of application No. 29/879,970, filed on Jul. 14, 2023.
(60) Provisional application No. 63/513,808, filed on Jul. 14, 2023.

(51) Int. Cl. A01D 7/06

(52) U.S. Cl. CPC A01D 7/06

(57) ABSTRACT

A rake assembly is provided with a base with a handle coupling, sized to extend laterally from the coupling. A plurality of tines extends from the base, away from the coupling. The plurality of tines is parallel and curved at distal ends of the tines and have a width that is greater than a thickness of the tines. The plurality of tines is spaced apart laterally by a spacing that is less than the width of the tines as a plurality of gaps. A length of the gaps is sequentially shortened laterally away from the coupling. A proximal end of the tines is coplanar or tangent to the base. A sidewall extends from a proximal end of the base and from lateral sides of the base, to collectively provide a shovel concavity with the base and the plurality of tines.

### CROSS-REFERENCE TO RELATED APPLICATIONS

This application is a continuation-in-part of U.S. application Ser. No. 29/879,970 filed Jul. 14, 2023, now U.S. Pat. No. ______; and this application claims the benefit of U.S. provisional application Ser. No. 63/513,808 filed Jul. 14, 2023; the disclosures of which are hereby incorporated in their entirety by reference herein.

### TECHNICAL FIELD

Various embodiments relate to rake assemblies.

### BACKGROUND

A leaf rake is disclosed in Stein et al., US Patent Application Publication 2021/0386013 A1, which published on Dec. 16, 2021, to The Ames Companies, Inc.

### SUMMARY

According to an embodiment, a rake assembly is provided with a base with a coupling to attach to a handle, and the base is sized to extend laterally from the coupling. A plurality of tines extends from the base, away from the coupling. The plurality of tines is parallel and curved at distal ends of the tines.

According to a further embodiment, the plurality of tines is spaced apart laterally by a spacing that is less than a width of the tines.

According to another further embodiment, the plurality of tines has a width that is greater than a thickness of the tines.

According to another further embodiment, a plurality of apertures is formed through the plurality of tines.

According to another further embodiment, the plurality of tines is spaced apart laterally by a plurality of gaps, wherein a length of the gaps is sequentially shortened laterally away from the coupling.

According to another further embodiment, a proximal end of the tines is coplanar or tangent to the base. A sidewall extends from the base to collectively provide a shovel concavity with the base and the plurality of tines.

According to another further embodiment, a sidewall extends from the base to collectively provide a shovel concavity with the base and the plurality of tines.

According to an even further embodiment, the sidewall is curved along the lateral sides of the base to converge with the plurality of tines.

According to another further embodiment, a plurality of elongate structural reinforcements is formed along the plurality of tines.

According to an even further embodiment, the plurality of elongate structural reinforcements converges at distal ends of the plurality of tines.

According to another even further embodiment, a sidewall extends from the base to collectively provide a shovel concavity with the base and the plurality of tines. The plurality of elongate structural reinforcements extends along a portion of the sidewall.

According to another further embodiment, the plurality of tines does not converge in a radial array.

According to another embodiment, a rake assembly is provided with a base with a coupling to attach to a handle, and the base is sized to extend laterally from the coupling. A plurality of tines extends from the base, away from the coupling. The plurality of tines is spaced apart laterally by a spacing that is less than a width of the tines.

According to another embodiment, a rake assembly is provided with a base with a coupling to attach to a handle, and the base is sized to extend laterally from the coupling. A plurality of tines extends from the base, away from the coupling. The plurality of tines has a width that is greater than a thickness of the tines.

According to another embodiment, a rake assembly is provided with a base with a coupling to attach to a handle, and the base is sized to extend laterally from the coupling. A plurality of tines extends from the base, away from the coupling. A plurality of apertures is formed through the plurality of tines.

According to another embodiment, a rake assembly is provided with a base with a coupling to attach to a handle, and the base is sized to extend laterally from the coupling. A plurality of tines extends from the base, away from the coupling. The plurality of tines is spaced apart laterally by a plurality of gaps, wherein a length of the gaps is sequentially shortened laterally away from the coupling.

According to another embodiment, a rake assembly is provided with a base with a coupling to attach to a handle, and the base is sized to extend laterally from the coupling. A plurality of tines extends from the base, away from the coupling. The plurality of tines is parallel and is curved at distal ends of the tines. A sidewall extends from the base to collectively provide a shovel concavity with the base and the plurality of tines.

According to a further embodiment, the plurality of tines is spaced apart laterally by a spacing that is less than a width of the tines.

According to another further embodiment, the plurality of tines has a width that is greater than a thickness of the tines.

According to another further embodiment, a plurality of apertures is formed through the plurality of tines.

According to another further embodiment, the plurality of tines is spaced apart laterally by a plurality of gaps, wherein a length of the gaps is sequentially shortened laterally away from the coupling.

According to another further embodiment, a proximal end of the tines is coplanar or tangent to the base.

According to another further embodiment, the sidewall extends from a proximal end of the base and from lateral sides of the base, to collectively provide the shovel concavity with the base and the plurality of tines, wherein the sidewall is curved along the lateral sides of the base to converge with the plurality of tines.

According to another embodiment, a rake assembly is provided with a base with a coupling to attach to a handle, and the base is sized to extend laterally from the coupling. A plurality of tines extends from the base, away from the coupling. The plurality of tines is parallel, and a proximal end of the tines are coplanar or tangent to the base. A sidewall extends from the base to collectively provide a shovel concavity with the base and the plurality of tines.

According to another embodiment, a rake assembly is provided with a base with a coupling to attach to a handle, and the base is sized to extend laterally from the coupling. A plurality of tines extends from the base. A sidewall extends from a proximal end of the base and from lateral sides of the base, to collectively provide a shovel concavity with the base and the plurality of tines. The sidewall is curved along the lateral sides of the base to converge with the plurality of tines.

According to another embodiment, a rake assembly is provided with a base with a coupling to attach to a handle, and the base is sized to extend laterally from the coupling. A plurality of tines extend from the base, away from the coupling. The plurality of tines is parallel, and curved at distal ends of the tines. The plurality of tines has a width that is greater than a thickness of the tines. The plurality of tines is spaced apart laterally by a spacing that is less than the width of the tines. A plurality of apertures is formed through the plurality of tines. The plurality of tines is spaced apart laterally by a plurality of gaps. A length of the gaps is sequentially shortened laterally away from the coupling. A proximal end of the tines is coplanar or tangent to the base. A sidewall extends from a proximal end of the base and from lateral sides of the base, to collectively provide a shovel concavity with the base and the plurality of tines. The sidewall is curved along the lateral sides of the base to converge with the plurality of tines.

### BRIEF DESCRIPTION OF THE DRAWINGS

FIG. 1 is a front perspective view of a rake assembly according to an embodiment;

FIG. 2 is a rear perspective view of the rake assembly of FIG. 1;

FIG. 3 is a front elevation view of the rake assembly of FIG. 1;

FIG. 4 is a perspective view of a user employing the rake assembly of FIG. 1 to rake leaves;

FIG. 5 is another perspective view of the user of FIG. 4 employing the rake assembly to rake leaves;

FIG. 6 is another perspective view of the user of FIG. 4 employing the rake assembly to shovel leaves;

FIG. 7 is another perspective view of the user of FIG. 4 employing the rake assembly to shovel leaves;

FIG. 8 is another perspective view of the user of FIG. 4 employing the rake assembly to shovel leaves;

FIG. 9 is a front perspective view of a rake assembly according to another embodiment;

FIG. 10 is a rear perspective view of the rake assembly of FIG. 9;

FIG. 11 is a front perspective view of a rake assembly according to another embodiment;

FIG. 12 is a front elevation view of the rake assembly of FIG. 11;

FIG. 13 is a rear elevation view of the rake assembly of FIG. 11;

FIG. 14 is a rear perspective view of the rake assembly of FIG. 11;

FIG. 15 is a left side elevation view of the rake assembly of FIG. 11;

FIG. 16 is a top view of the rake assembly of FIG. 11; and

FIG. 17 is a bottom view of the rake assembly of FIG. 11.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

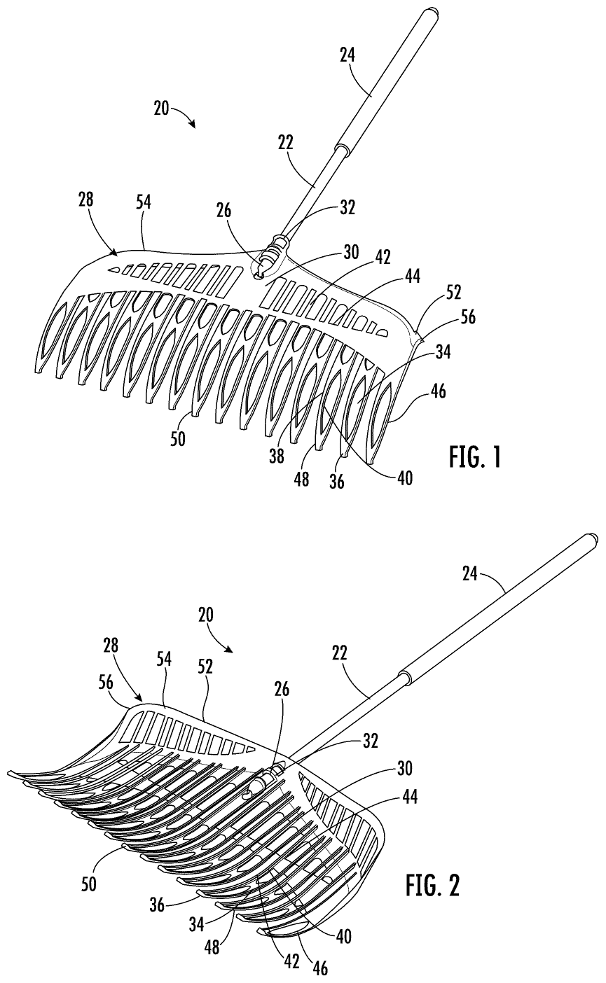

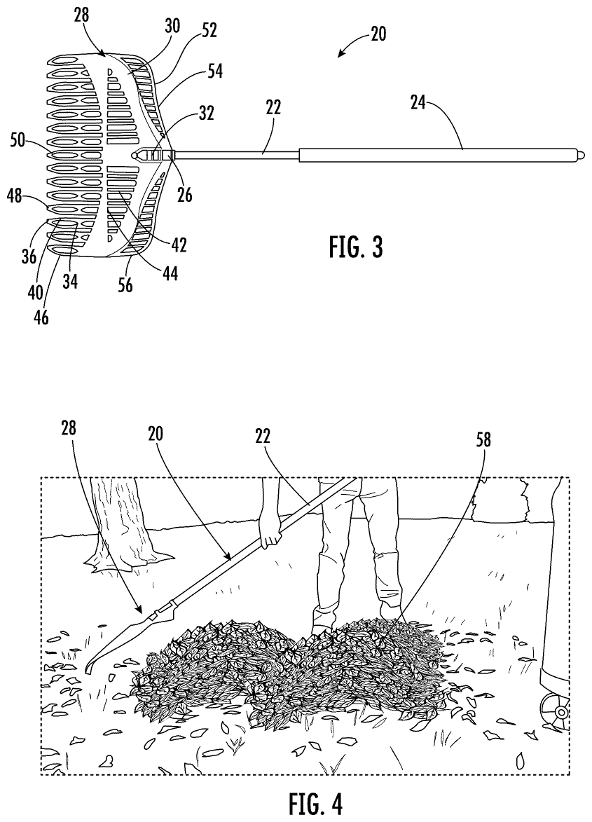

FIGS. 1-3 illustrate a rake assembly 20 according to an embodiment. The rake assembly 20 is a horticultural tool, which may be employed for raking, and shoveling leaves, grass, hay, and other lawn waste or debris. The rake assembly 20 includes an elongate shaft as a handle 22. The handle 22 may be formed from wood, metal, a polymeric material, a fiber reinforced material, or the like. Since the rake assembly 20 may be utilized for work on relatively lightweight substances, the handle 22 may be formed from a high strength, yet lightweight material. A flexible grip 24, such as an elastomeric sleeve, a foam coating or the like, may be provided on the handle 22 for comfort to the end user. The handle 22 includes a proximal end 26 that extends away from the grip 24.

The rake assembly 20 also includes base 28 that provides both a rake head and a shovel blade. The base 28 may be formed as one piece, such as from a polymeric material, for example, polypropylene, polyethylene, or the like. Likewise, the base 28 may be formed unitarily, such as from an injection molded plastic. The unitary polymeric base 28 provides a lightweight, and structurally resilient rake assembly 20 that is adequate for handling lightweight waste and debris.

The base 28 includes a substrate 30 that extends away from the handle 22, while also extending outward laterally away from the handle 22. The substrate 30 provides a head or frame of the rake, while also providing a portion of the shovel blade. In the depicted embodiment, the base 28 also includes a coupling 32 that is sized to receive the proximal end 26 of the handle 22. The coupling 32 may be a receptacle, or any suitable retainer for receiving and attaching the handle 22, as is known in the art. In the depicted embodiment, the substrate 30 is aligned to be at least partially parallel to a longitudinal axis of the handle 22. The substrate 30 may also lie at least partially in a plane that is parallel with the longitudinal axis of the handle 22.

A plurality of tines 34 extend from the substrate 30, in a direction away from the coupling 32 and the handle 22, to perform both raking and shoveling functions. The tines 34 are arranged in a parallel array. The tines 34 do not converge at the base 28 in a radial array, as in the prior art, to avoid bunching of the leaves while raking and shoveling. The tines 34 are also curved away from the substrate 30 so that distal ends 36 extend downward toward an underlying support surface during a raking operation. The tines 34 are significantly wide to collectively form portions of the shovel blade during a shoveling operation. Therefore, the tines 34 each have a width in a lateral direction that is greater than a lateral gap spacing 38 between sequential tines 34. Each of the tines 34 is also tapered such that the width of each tine 34 narrows to the distal end 36.

The tines 34 each have a thickness, which is generally consistent with a thickness of the substrate 30. This consistency aids the tines 34 as forming a portion of the shovel blade with the substrate 30. The width of each tine 34 is greater than the thickness of each tine 34. This relationship permits a cantilevered flexibility to each tine 34 for functioning as rake tines 34. The flexibility of the tines 34 is also tuned for the particular application by the inclusion of apertures 40 through the tines 34. The apertures 40 also lighten the weight of the rake assembly 20 by avoiding unnecessary material.

As illustrated in FIG. 2, the base 28 includes a plurality of elongate structural reinforcements, or ribs 42, formed along a back surface of the tines 34. The ribs 42 add structural rigidity to the tines 34 without increasing the thickness of the entire tine 34. The ribs 42 converge at the distal ends 36 of the tines 34. The ribs 42 also extend rearward, and overlap the substrate 30. An opening 44 is formed in the substrate 30. The ribs 42 may extend across the opening 44 to interconnect the substrate 30. The opening 44 may be formed by a plurality of apertures 44 formed in the substrate 30 thereby forming the ribs 42 across the opening 44. The ribs 42 provide a continuous guide path from the tines 34 to the substrate 30 within the base 28.

The gaps 38 between the tines 34 are formed to different lengths, with a reduced length at the laterally outboard gaps 38. The varied gap 38 lengths vary the flexibility of the tines 34 such that laterally outboard tines 46 are less flexible than intermediate tines 48. The intermediate tines 48 are, in turn, less flexible than the central tines 50.

The base 28 includes a sidewall 52 extending from the substrate 30. The sidewall 52, the substrate 30, and the tines 34 collectively provide a shovel blade with a shovel concavity for performing a shoveling operation. The ribs 42 extend along a rear portion 54 of the sidewall 52 to interconnect the sidewall rear portion 54 to the substrate 30. Additionally, the ribs 42 extend from the distal ends 36 of the tines 34 to the rear portion of the sidewall 52 to provide continuous contact surfaces or guides to the grass, leaves, or debris for a continuous translation upon the ribs 42 of the tines 34, substrate 30 and the sidewall 52.

The tines 34 have a curvature that is tangent to the substrate 30 for a continuous scoop or shoveling motion. The sidewall rear portion 54 extends away from the substrate 30 in the same direction that the tines 34 curve away from the substrate 30 to add to the concavity of the base for scooping and retaining shoveled waste, or debris. The sidewall 52 includes lateral sidewall portions 56 that curve away from the substrate to provide lateral support and to add to the concavity of the base 28.

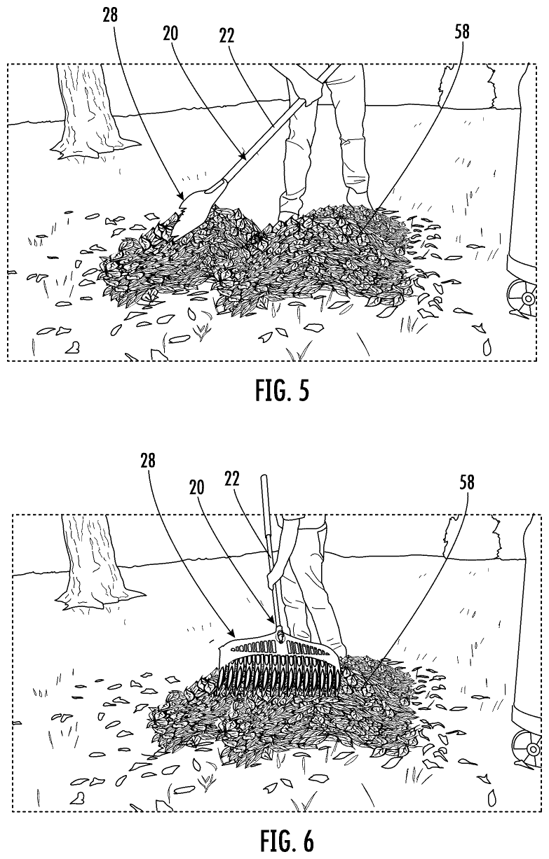

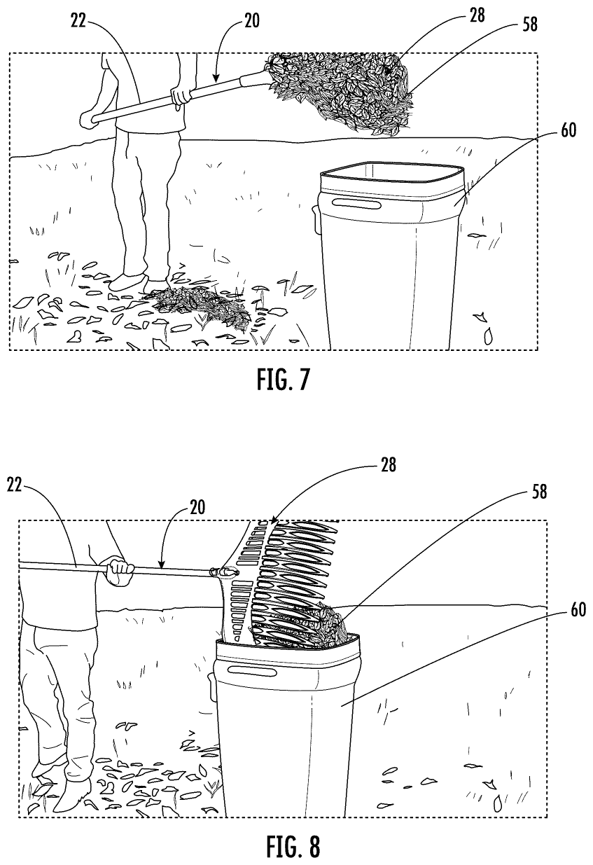

FIGS. 4 and 5 illustrate a user utilizing the rake assembly 20 as a rake. The rake assembly 20 is held with the tines 34 turned downward to engage and move leaves 58. As the rake head 28 is dragged through the leaves 58, the leaves 58 move from an initial position in FIG. 4, to a leaf pile in FIG. 5. In FIG. 6, the rake assembly 20 is rotated 180 degrees about the longitudinal axis of the handle 22 such that the tines 34 face upward. In FIG. 6, the rake assembly 20 is illustrated as a shovel, which is slid beneath the pile of leaves 58 to scoop a portion of the leaves 58. The leaves 58 are raised over a wastebin 60 in FIG. 7, and then the leaves 58 are dumped into the wastebin 60 in FIG. 8, by turning the shovel base 28 over such that the leaves 58 fall from the concavity of the base 28.

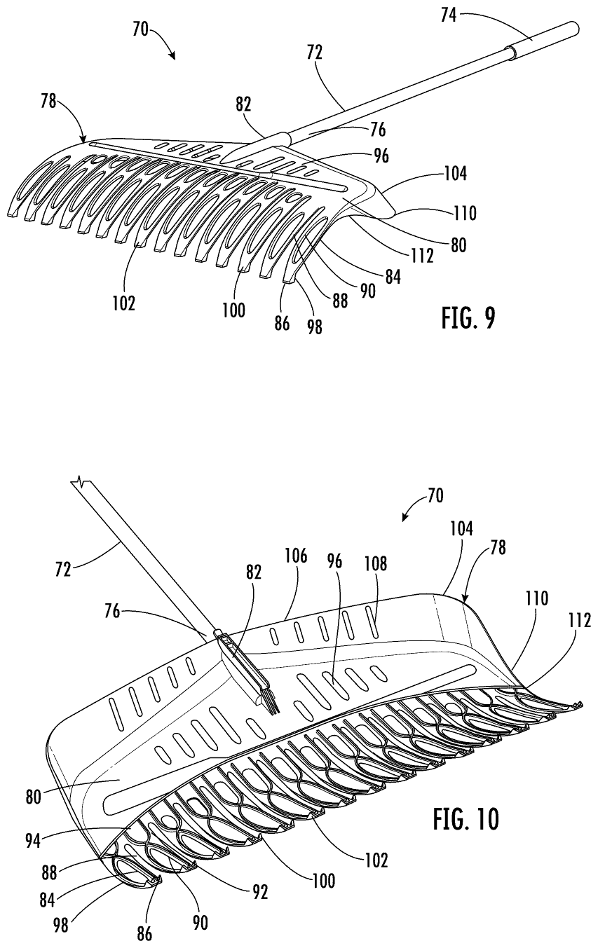

FIGS. 9 and 10 illustrate a rake assembly 70 according to another embodiment. The rake assembly 70 includes a handle 72. A flexible grip 74, such as an elastomeric sleeve, a foam coating or the like, may be provided on the handle 72 as exemplified in FIG. 9, for comfort to the end user. The handle 72 includes a proximal end 76 that extends away from the grip 74.

The rake assembly 70 also includes base 78 that provides both a rake head and a shovel blade. The base 78 includes a substrate 80 that extends away from the handle 72, while also extending outward laterally away from the handle 72. The substrate 80 provides a head or frame of the rake, while also providing a portion of the shovel blade. In the depicted embodiment, the base 78 also includes a coupling 82 that is sized to receive the proximal end 76 of the handle 72. The coupling 82 may be a receptacle, or any suitable retainer for receiving and attaching the handle 72, as is known in the art. The coupling 82 may also include a release mechanism, as is also known in the art for rapid connection and disconnection. In the depicted embodiment, the substrate 80 is aligned to be at least partially parallel to a longitudinal axis of the handle 72. The substrate 80 may also lie at least partially in a plane that is parallel with the longitudinal axis of the handle 72.

A plurality of tines 84 extend from the substrate 80, in a direction away from the coupling 82 and the handle 72, to perform both raking and shoveling functions. The tines 84 are arranged in a parallel array. The tines 84 do not converge at the base 78 in a radial array, as in the prior art, to avoid bunching of the leaves while raking and shoveling. The tines 84 are also curved away from the substrate 80 so that distal ends 86 extend downward toward an underlying support surface during a raking operation. The tines 84 are significantly wide to collectively form portions of the shovel blade during a shoveling operation. Therefore, the tines 84 each have a width in a lateral direction that is greater than a lateral gap spacing 88 between sequential tines 84. Each of the tines 84 is also tapered such that the width of each tine 84 narrows to the distal end 86.

The tines 84 each have a thickness, which is generally consistent with a thickness of the substrate 80. This consistency aids the tines 84 as forming a portion of the shovel blade with the substrate 80. The width of each tine 84 is greater than the thickness of each tine 84. This relationship permits a cantilevered flexibility to each tine 84 for functioning as rake tines 84. The flexibility of the tines 84 is also tuned for the particular application by the inclusion of apertures 90 through the tines 84. The apertures 90 also lighten the weight of the rake assembly 70 by avoiding unnecessary material.

As illustrated in FIG. 10, the base 78 includes a plurality of elongate structural reinforcements, or ribs 92, formed along a back surface of the tines 84. The ribs 92 add structural rigidity to the tines 84 without increasing the thickness of the entire tine 84. The ribs 92 converge at the distal ends 86 of the tines 84. The ribs 92 extend rearward of the distal ends 86, around one of the apertures 90. The ribs 92 extend further rearward and converge to intersect between a pair of the apertures 90. The ribs 92 diverge again and extend further rearward around another aperture 90. The ribs 92 provide a continuous guide path from the tines 84 to the substrate 80 within the base 78. Another rib or cross brace 94 may be provided laterally to provide support between the tines 84 and the substrate 80. The substrate 80 may also include a plurality of apertures 96 for reducing the material and weight of the base 78.

As depicted in FIGS. 9 and 10, the gaps 88 between the tines 84 are formed to different lengths, with a reduced length at the laterally outboard gaps 88. The varied gap 88 lengths vary the flexibility of the tines 84 such that laterally outboard tines 98 are less flexible than intermediate tines 100. The intermediate tines 100 are, in turn, less flexible than the central tines 102.

The base 78 includes a sidewall 104 extending from the substrate 80. The sidewall 104, the substrate 80, and the tines 84 collectively provide a shovel blade with a shovel concavity for performing a shoveling operation. The sidewall 104 includes a rear portion 106 (FIG. 10) with apertures 108 for a weight and material reduction. The tines 84 have a curvature that is tangent to the substrate 80 for a continuous scoop or shoveling motion. The sidewall rear portion 106 extends away from the substrate 80 in the same direction that the tines 84 curve away from the substrate 80 to add to the concavity of the base for scooping and retaining shoveled waste, or debris.

Referring again to FIGS. 9 and 10, the sidewall 104 includes lateral sidewall portions 110 that curve away from the substrate 80 to provide lateral support and to add to the concavity of the base 78. The lateral sidewall portions 110 have a curvature that converges or tapers at the outward tines 98. The curvature in the sidewall portions 110 provides a dip 112, which permits a smoother poor out of a payload of debris, such as leaves. Conversely, a full wall design would require the user to turn the rake assembly 70 over more each time to dump out the debris.

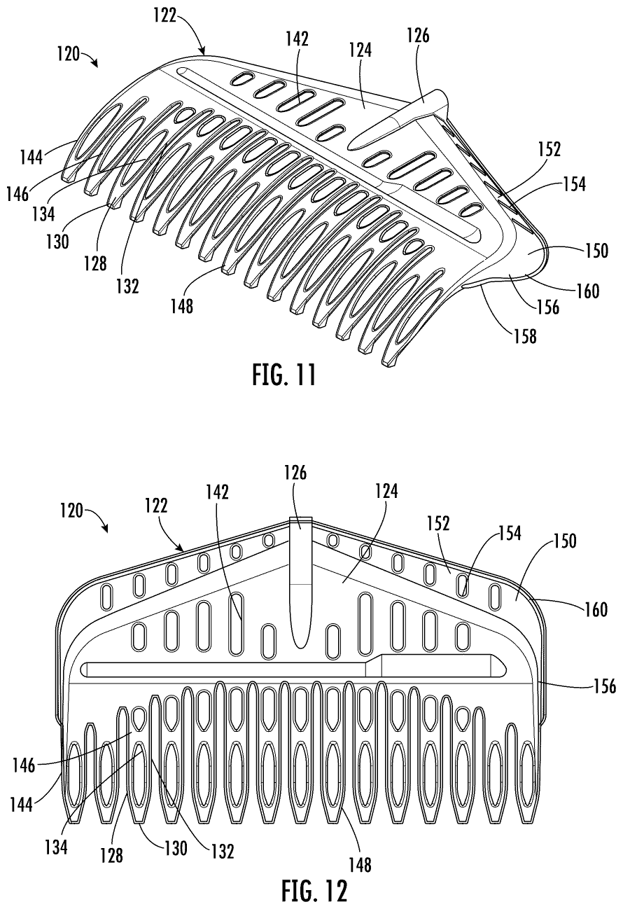

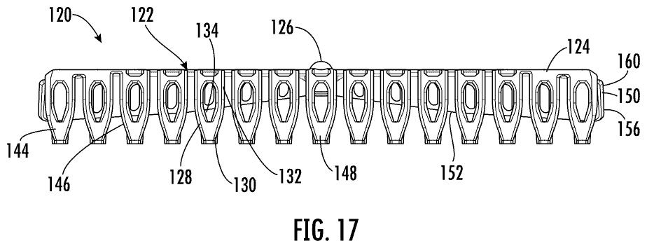

FIGS. 11-17 illustrate a rake assembly 120 according to another embodiment. The rake assembly 120 also includes base 122 that provides both a rake head and a shovel blade. The base 122 includes a substrate 124 that extends away from a coupling 126, while also extending outward laterally away from the coupling 126. The substrate 124 provides a head or frame of the rake, while also providing a portion of the shovel blade. In the depicted embodiment, the coupling 126 is sized to receive a proximal end of a handle. The coupling 126 may be a receptacle, or any suitable retainer for receiving and attaching the handle, as is known in the art. The coupling 126 may also include a release mechanism, as is also known in the art for rapid connection and disconnection. In the depicted embodiment, the substrate 124 is aligned to be at least partially parallel to a longitudinal axis of the coupling 126. The substrate 124 may also lie at least partially in a plane that is parallel with the longitudinal axis of the coupling 126.

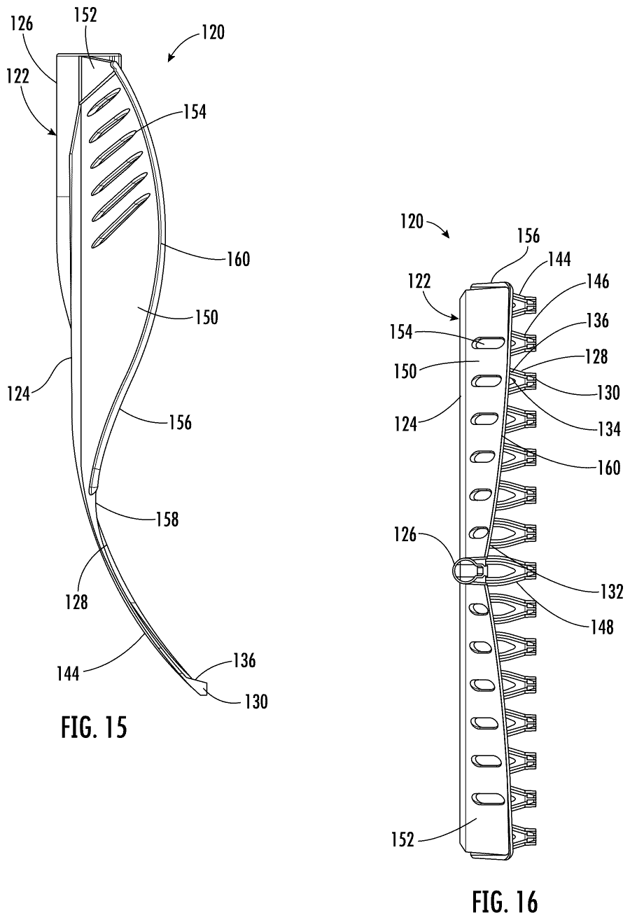

A plurality of tines 128 extend from the substrate 124, in a direction away from the coupling 126, to perform both raking and shoveling functions. The tines 128 are arranged in a parallel array. The tines 128 do not converge at the base 122 in a radial array, as in the prior art, to avoid bunching of the leaves while raking and shoveling. The tines 128 are also curved away from the substrate 124 so that distal ends 130 extend downward toward an underlying support surface during a raking operation. With reference to FIG. 15, the tines 128 terminate at the distal ends after a gradual curvature. The tines 128 do not include a distinct bend, as in prior art rakes, that would upset a smooth scooping operation as a shovel. The distal ends 130 of the tines 128 include an anti-clogging geometry, which is known in the art, to prevent clogging of leaves or other debris within the tines 128.

Now with reference again to FIGS. 11-17, the tines 128 are significantly wide to collectively form portions of the shovel blade during a shoveling operation. Therefore, the tines 128 each have a width in a lateral direction that is greater than a lateral gap spacing 132 between sequential tines 128. Each of the tines 128 is also tapered such that the width of each tine 128 narrows to the distal end 130. The tines 128 each have a thickness, which is generally consistent with a thickness of the substrate 124. This consistency aids the tines 128 as forming a portion of the shovel blade with the substrate 124. The width of each tine 128 is greater than the thickness of each tine 128. This relationship permits a cantilevered flexibility to each tine 128 for functioning as rake tines 128. The flexibility of the tines 128 is also tuned for the particular application by the inclusion of apertures 134 through the tines 128. The apertures 134 also lighten the weight of the rake assembly 120 by avoiding unnecessary material.

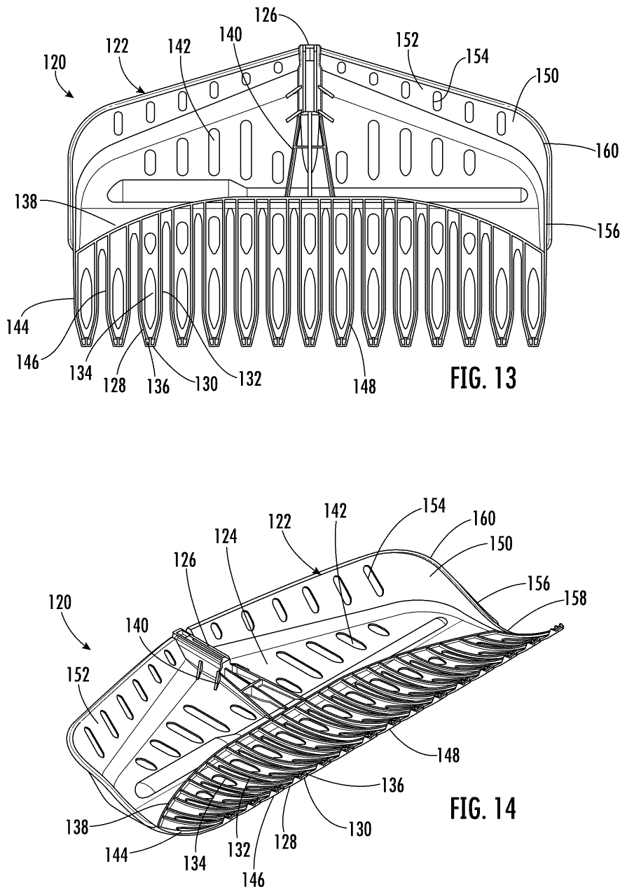

As illustrated in FIGS. 13-16, the base 122 includes a plurality of elongate structural reinforcements, or ribs 136, formed along a back surface of the tines 128. The ribs 136 add structural rigidity to the tines 128 without increasing the thickness of the entire tine 128. The ribs 136 converge at the distal ends 130 of the tines 128. The ribs 136 increase in height at the distal ends 130 to extend further away from the tines 128 to form the clog resistant geometry. The ribs 136 extend rearward of the distal ends 130, around the apertures 134. The ribs 136 provide a continuous guide path from the tines 128 to the substrate 124 within the base 122. Another rib or cross brace 138 may be provided laterally to provide support between the tines 128 and the substrate 124 as illustrated in FIGS. 13 and 14. Additional ribs 140 may be provided about the coupling 126 to support the substrate 124 relative to the coupling 126. With reference to FIGS. 11-14, the substrate 124 may also include a plurality of apertures 142 for reducing the material and weight of the base 122.

With continued reference to FIGS. 11-14, the gaps 132 between the tines 128 are formed to different lengths, with a reduced length at the laterally outboard gaps 132. The varied gap 132 lengths vary the flexibility of the tines 128 such that laterally outboard tines 144 are less flexible than intermediate tines 146. The intermediate tines 146 are, in turn, less flexible than the central tines 148.

Referring again to FIGS. 11-17, the base 122 includes a sidewall 150 extending from the substrate 124. The sidewall 150, the substrate 124, and the tines 128 collectively provide a shovel blade with a shovel concavity for performing a shoveling operation. The sidewall 150 includes a rear portion 152 as a high back for the shovel scoop or basket. The rear portion 152 is provided with apertures 154 for a weight and material reduction. The tines 128 have a curvature that is tangent to the substrate 124 for a continuous scoop or shoveling motion. The sidewall rear portion 152 extends away from the substrate 124 in the same direction that the tines 128 curve away from the substrate 124 to add to the concavity of the base for scooping and retaining shoveled waste, or debris.

Referring to FIGS. 11 and 15, the sidewall 150 includes lateral sidewall portions 156 that curve away from the substrate 124 to provide lateral support and to add to the concavity of the base 122. The lateral sidewall portions 156 have a curvature that converges or tapers at the outward tines 144. The curvature in the sidewall portions 156 provides a dip 158, which permits a smoother poor out of a payload of debris, such as leaves. Conversely, a full wall design would require the user to turn the rake assembly 120 over more each time to dump out the debris. A peripheral projection or lip 160 extends around a periphery of the sidewall 150 to provide additional support as a stiffener to the sidewall 150.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A rake assembly comprising:
a base with a coupling to attach to a handle, and sized to extend laterally from the coupling; and
a plurality of tines extending from the base, away from the coupling, wherein the plurality of tines is parallel, and curved at distal ends of the tines.

2. The rake assembly of claim 1, wherein the plurality of tines is spaced apart laterally by a spacing that is less than a width of the tines.

3. The rake assembly of claim 1, wherein the plurality of tines has a width that is greater than a thickness of the tines.

4. The rake assembly of claim 1, wherein a plurality of apertures is formed through the plurality of tines.

5. The rake assembly of claim 1, wherein the plurality of tines is spaced apart laterally by a plurality of gaps, wherein a length of the gaps is sequentially shortened laterally away from the coupling.

6. The rake assembly of claim 1, wherein a proximal end of the tines is coplanar or tangent to the base; and
wherein the rake assembly further comprises a sidewall extending from the base to collectively provide a shovel concavity with the base and the plurality of tines.

7. The rake assembly of claim 1, further comprising a sidewall extending from the base to collectively provide a shovel concavity with the base and the plurality of tines.

8. The rake assembly of claim 7, wherein the sidewall is curved along the lateral sides of the base to converge with the plurality of tines.

9. The rake assembly of claim 1, further comprising a plurality of elongate structural reinforcements formed along the plurality of tines.

10. The rake assembly of claim 9, wherein the plurality of elongate structural reinforcements converges at distal ends of the plurality of tines.

11. The rake assembly of claim 9, wherein the rake assembly further comprises a sidewall extending from the base to collectively provide a shovel concavity with the base and the plurality of tines; and
wherein the plurality of elongate structural reinforcements extends along a portion of the sidewall.

12. The rake assembly of claim 1, wherein the plurality of tines does not converge in a radial array.

13. A rake assembly comprising:
a base with a coupling to attach to a handle, and sized to extend laterally from the coupling;
a plurality of tines extending from the base, away from the coupling, wherein the plurality of tines is parallel, and is curved at distal ends of the tines; and
a sidewall extending from the base to collectively provide a shovel concavity with the base and the plurality of tines.

14. The rake assembly of claim 13, wherein the plurality of tines is spaced apart laterally by a spacing that is less than a width of the tines.

15. The rake assembly of claim 13, wherein the plurality of tines has a width that is greater than a thickness of the tines.

16. The rake assembly of claim 13, wherein a plurality of apertures is formed through the plurality of tines.

17. The rake assembly of claim 13, wherein the plurality of tines is spaced apart laterally by a plurality of gaps, wherein a length of the gaps is sequentially shortened laterally away from the coupling.

18. The rake assembly of claim 13, wherein a proximal end of the tines is coplanar or tangent to the base.

19. The rake assembly of claim 13, wherein the sidewall extends from a proximal end of the base and from lateral sides of the base, to collectively provide the shovel concavity with the base and the plurality of tines, wherein the sidewall is curved along the lateral sides of the base to converge with the plurality of tines.

20. A rake assembly comprising:
a base with a coupling to attach to a handle, and sized to extend laterally from the coupling;
a plurality of tines extending from the base, away from the coupling, wherein the plurality of tines is parallel, and curved at distal ends of the tines, wherein the plurality of tines has a width that is greater than a thickness of the tines, wherein the plurality of tines is spaced apart laterally by a spacing that is less than the width of the tines, wherein a plurality of apertures is formed through the plurality of tines, wherein the plurality of tines is spaced apart laterally by a plurality of gaps, wherein a length of the gaps is sequentially shortened laterally away from the coupling, wherein a proximal end of the tines are coplanar or tangent to the base; and
a sidewall extending from a proximal end of the base and from lateral sides of the base, to collectively provide a shovel concavity with the base and the plurality of tines, wherein the sidewall is curved along the lateral sides of the base to converge with the plurality of tines.

21-26. (canceled)
